(19) United States
(12) Patent Application Publication
(10) Pub. No.: US 2012/0186658 A1
(43) Pub. Date: Jul. 26, 2012

(54) WATER TREATMENT SYSTEM

(75) Inventors: Roy W. Kuennen, Caledonia, MI (US); Kenneth E. Conrad, Ada, MI (US); Audrey Conrad, Rockford, MI (US); Terry L. Lautzenheiser, Nunica, MI (US); Ryan D. Schamper, Grand Haven, MI (US)

(73) Assignee: ACCESS BUSINESS GROUP INTERNATIONAL LLC, Ada, MI (US)

(21) Appl. No.: 13/356,092

(22) Filed: Jan. 23, 2012

Related U.S. Application Data
(60) Provisional application No. 61/435,531, filed on Jan. 24, 2011.

(51) Int. Cl. E03B 7/07; F17D 1/16

(52) U.S. Cl. 137/14; 137/544

(57) ABSTRACT

A water treatment system is provided including a disinfection system, a filter and a turbine generator. A manual pump is positioned downstream of the filter to create negative pressure to draw water through the filter. The manual pump also creates positive pressure to dispense treated water from the outlet of the system. The movement of the water through the system powers the turbine generator. The power generated can be used to monitor a characteristic of the water treatment system.

U.S. Pat. No. 7,663,257 to Baarman entitled Self-Powered Miniature Liquid Treatment System with Configurable Hydropower Generator is herein incorporated by reference in its entirety.

### BACKGROUND OF THE INVENTION

As the world's population increases, the demand for water also increases. Additionally, many wellheads are running dry due to the lowering of underground aquifers, resulting in new wells being drilled to deeper depths, in an attempt to find water. In many cases, high costs prohibit these operations. Further, in many locales where water is very scarce, the population is unable to purchase water for consumption due to their low income levels and the fact that municipally treated water is unavailable. Examples of such settings may include rural villages in under-developed countries, emergency relief sites following natural disasters, or camp settings, to name a few.

Modern municipal water treatment systems, where available, are equipped to treat and distribute water for human consumption. In many cases, this treatment involves coagulation, flocculation and sedimentation of particulate matter. Additional filtering of the water may also be conducted, as well as treatment with chlorine. Due to the nature of a municipal system, the treated water may not be consumed immediately, and the chlorine remains in the water until it is dispensed.

When water is treated in a home beyond a municipal system (if one is available) the system is commonly referred to as a point-of-use (POU) system. Many POU systems are intended for homes with reliable access to supply water at relatively high pressure (>20 psi). Additionally, these homes generally have access to electricity or other energy sources to operate pumps to pressurize water and to run electronic devices generally found in some POU systems. Most of these systems require potable water to be supplied at the inlet.

As a result, there is a need for a home POU system for those who lack access to potable municipal water and who may not have access to electric power or other energy sources. It is desirable for the system to be useful in a variety of applications, such as treating water for consumption in the home, disaster relief and outdoor activities. A water treatment system that is smaller and more portable would also be desirable. In addition, an increased flow rate through the system would enhance ease of use and provide other benefits.

### SUMMARY OF THE INVENTION

In one aspect, a water treatment system is provided with a manual pump. In one embodiment, the water treatment system provides active and automatic monitoring, where power to perform the monitoring is derived from pumping water through the water treatment system with the manual pump. In one embodiment, as water is pumped through the water treatment system, power can be generated by a hydropower generator, sometimes referred to as a turbine, such as the hydropower generator described in U.S. Pat. No. 7,663,257, which was previously incorporated by reference. Although the water pressure profile created by the manual pump may be low and erratic, sufficient power to perform the monitoring may still be generated. The monitoring can be performed without the use of an external power source, such as a replaceable battery, solar panel, or power cord. In one embodiment, activation of the manual pump provides both high flow rate and automatic dispensing of the water. In one embodiment, the movement of the pump lever in a first direction (for example, upward) can allow the user to meter water amounts by stopping the motion of the lever in the first direction. The return to home stroke in a second direction (for example, downward) may be designed not to pump water. The pump lever can be telescoping to allow compact storage with user selectable effort levels by selecting the extension length of the telescoping pump lever. In embodiments that include a filter, the addition of pressure from the manual pump allows a higher performance filtration stage because high removal carbon blocks have substantial flow resistance.

In another aspect, a water treatment system is provided that is capable of holding water in a partially treated state, sometimes referred to as a mid process and safe state. While water is held in this partially treated state, concern of regrowth and reinfection of the processed water over the hold time between normal uses can be substantially reduced. Holding water in a mid process can allow the water treatment system to be compact and more portable by eliminating the need for a second tank dedicated to holding ready to drink water.

In another aspect, a water treatment system is provided with a pump located down stream from the storage container and filter. In one embodiment, the pump can provide negative pressure and allow the storage container to be unpressurized, reducing cost and complexity. In another embodiment, the location of the pump downstream from the filtration protects the pump mechanism from fouling and wear due to water contaminants, particularly corrosive chemistry and particulates.

In another aspect, a water treatment system is provided with a disinfectant agent doser, such as a Chlorine tablet dosing mechanism. The disinfectant agent doser can be located and easily maintained in an inlet container where it is in full view every time the unit is replenished. The disinfectant agent doser can be a one piece unit that does not require tools for installation and maintenance replacement..

These and other objects, advantages, and features of the invention will be more fully understood and appreciated by reference to the description of the current embodiments and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1 illustrates an exemplary flow path through a water treatment system.

FIG. 2A illustrates an exemplary water treatment system with a telescoping manual pump.

FIG. 2B illustrates the water treatment system of FIG. 2A with the fill lid open.

FIG. 2C illustrates the water treatment system of FIG. 2A with the pump lever telescoped outward.

FIG. 2D illustrates the water treatment system of FIG. 2A with the pump lever raised.

FIG. 3 illustrates a top perspective view of the water treatment system of FIG. 2A.

FIG. 4 illustrates a top perspective view of the water treatment system of FIG. 2A with the inlet removed.

FIG. 5 illustrates an exploded view of the water treatment system of FIG. 2A.

FIG. 6 illustrates an exploded view of some of the components of the water treatment system of FIG. 2A.

### DESCRIPTION OF THE CURRENT EMBODIMENT

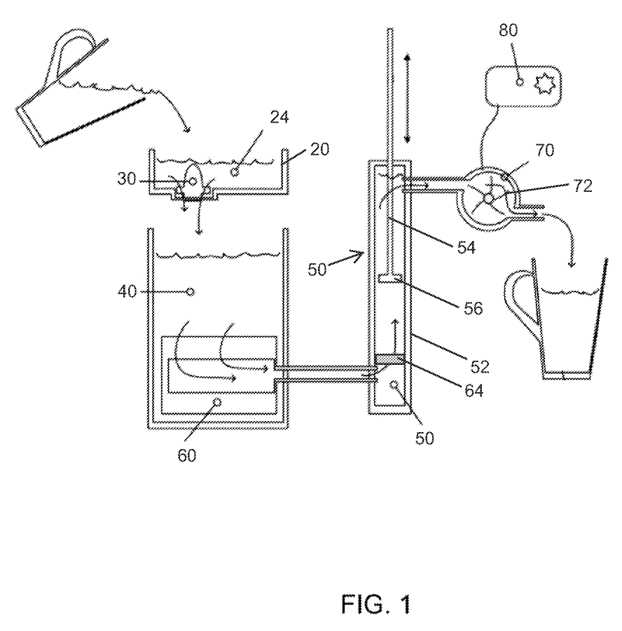

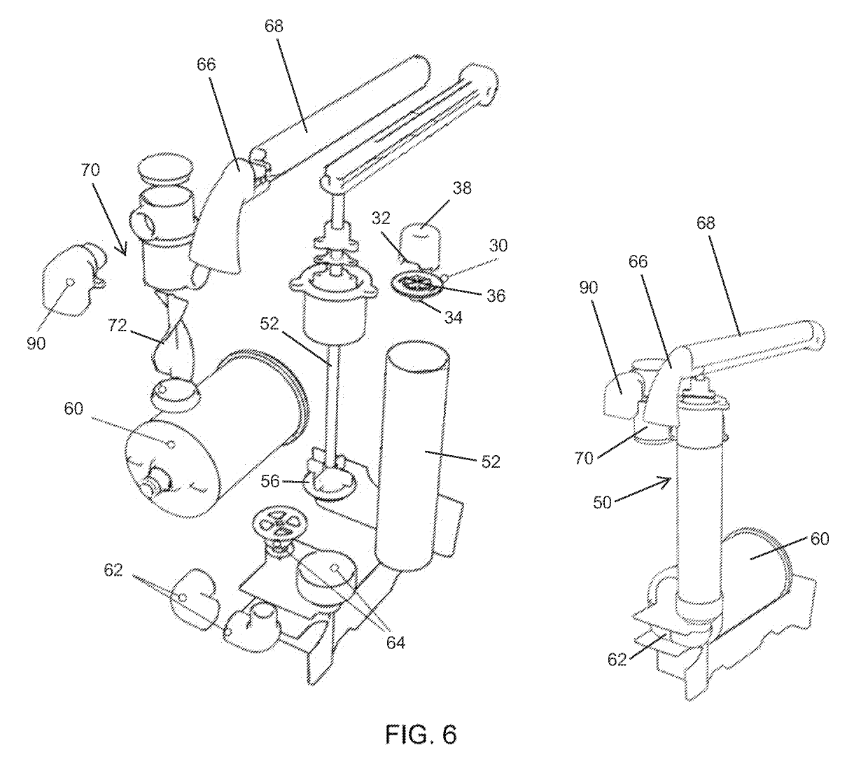

Referring to FIG. 1, one embodiment of a flow path through a water treatment system is illustrated. Water can be added to the system as desired. For example, water may be added at the time of desired consumption or may be added in anticipation of consuming the water at a later time. Although the current embodiment is a water treatment system, it should be understood that the system could be utilized for treating essentially any liquid. In the current embodiment, the water treatment system is designed to accept non-potable water that can benefit from chemical disinfection, such as chlorination, and filtration. Once water is added to the inlet 20, the water passes through the chemical disinfection doser 30. The chemical disinfection doser 30 can be a variety of different shapes and sizes. The chemical disinfection doser 30 in the current embodiment is a chlorinator. One embodiment of a chlorinator 30 capable of being utilized in the current embodiment is illustrated in FIG. 6, and will be discussed in more detail below. After chlorination, the water flows into a container 40. In the current embodiment, the container is a disinfection contact time container 40, where the water is held until the pump 50 is activated, drawing the water through the carbon block filter 60. As illustrated, the water may move from the inlet 20, through the inlet cavity 24, through the chlorinator 30 and into the container 40 under the power of gravity. Holding water in a mid process, chlorinated state in this case, allows the water treatment system to be compact because a second tank dedicated to holding ready water is unnecessary. The container 40 can be transparent, translucent, or opaque. In embodiments where the water level in the container 40 is not visible to a user looking at the outside of the container 40, the container 40 may include an indicator for indicating the level of water in the container 40. For example, the container 40 may include a small vertical transparent or translucent sight window that allows the user to see how much water is in the container 40. The window may have a thickness such that a majority of the inside of the container 40 cannot clearly be seen through the sight window, but the level of liquid in the container 40 can be seen through the sight window.

As the water is drawn through the system the water pressure produced by the pump 50 causes the blades of the generator 70 to turn, which produces energy that can be utilized to power a status indicator 80, such as a display. The status indicator 80 can be an LCD panel, a sound system, a light system, or essentially any other system that can indicate the status of the water treatment system. In one embodiment, the status indicator 80 can indicate the status of the filter 60 or the disinfection doser 30 and is capable of indicating that the filter 60 or disinfection tablet should be replaced. In the current embodiment, as the blades 72 turn, a counter located on the generator counts the amount of water that flows through the system. Alternatively, rather than a mechanical or magnetic counter, a microprocessor may be utilized to track the amount of power generated by the turbine 70 and calculate the amount of water that flows through the generator 70 based on the relationship between the amount of power generated for a particular amount of water flowing through the system. In some embodiments, the water treatment system may include a battery that can be charged by the generator 70 so that the display 80 can be run even while the generator 70 is not active. After flowing through the generator 70, the water can be dispensed for consumption.

In one embodiment, the manual pump 50 of the water treatment system produces sufficient energy to actively and automatically monitor the flow of water through the water treatment system. The pump action provides both high flow rate sufficient to move the water through the system and automatic dispensing of the water through the outlet or dispenser port 90. In one embodiment, the flow rate is at least 6 fluid ounces per stroke of the manual pump 50. In alterative embodiments the flow rate can be higher or lower than 6 fluid ounces per stroke of the manual pump 50. In some embodiments, one or more components of the water treatment system may restrict the flow rate to a particular flow rate. In some embodiments, a flow rate restrictor may be included somewhere within the water treatment system. For example, the dispenser 90 may include a flow rate restrictor orifice or the filter 60 may be designed to restrict the flow rate of water that flows through it.

In alternative embodiments, it may be possible to use a pump 50 to move the water through the system and utilize a dispenser 90 to dispense the water instead of having automatic dispensation of the water. In the current embodiment, the pump 50 allows the user to meter the amount of water dispensed by stopping the motion of the lever arm 68. That is, in the current embodiment, the pump 50 is only active in one direction, as it is raised. As the pump 50 is lowered back to its home position, no water is pumped. In alternative embodiments, a two-way or continuous flow pump could be utilized. In other embodiments, the pump lever action may operate in a horizontal or other direction, or may be a circular motion mechanism. Utilizing the one way pump allows a user to dispense a small amount of water, and return the pump lever 68 to its home position without dispensing any additional water. The pump lever 68 of the current embodiment is telescoping, which allows compact storage when retracted. When telescoped, depending on how far the user selects to telescope the manual pump lever 68, the amount of effort it takes to pump water through the system can be adjusted. Further, depending on how far the user selects to telescope the manual pump lever 68, the resolution of the amount of water that is dispensed may be adjusted. In some embodiments, the pressure produced by the manual pump 50 can be significant. There can be enough pressure provided such that a higher performance filter 60 that has a substantial flow resistance can be utilized. Without the pressure provided by the manual pump 50, use of such a high performance filter 60 may be difficult. In the current embodiment the filter 60 is a high removal radial carbon block filter, in alternative embodiments, different types of filters may be utilized.

Because in the current embodiment there is no plumbing that provides pressurized water at the inlet 20, the low and erratic water pressure profile provided by a manual pump can only provide a certain amount of energy. Accordingly, in one embodiment, a turbine 70 can act both as an electricity generator and as a mechanical counter for tracking the amount of water flowing through the system. For example, as the turbine blades 72 are turned, electrical current can be produced and stored in a storage element such as a battery or super capacitor. Even a very small amount of energy, such as the amount produced by the manual pump 50, may be capable of providing sufficient energy to power a status indicator 80 for a significant portion of the life of the water treatment system. In addition, the turbine 70, while conducting electricity, can also easily interact with a magnet to count the number of rotations of the turbine blade 72, and therefore the volume of water passing through the system. This information can then be compared to a threshold to determine when an indication for filter change should be issued. The calculation can be done with or without a microprocessor circuit. In alternative embodiments, the ability to monitor flow through the water treatment system may be provided in other ways, such as tracking the amount of energy produced by the turbine 70 and calculating the amount of water flowing through the system based on a known relationship between water flowing through the system and the amount of energy a specific amount of water flowing produces. Accordingly, the status of the filter 60 can be closely monitored and the user can be notified when it is time to change the filter. In other embodiments, additional or different characteristics of the water treatment system can be monitored. The system does not require external power. For example, a replaceable battery or power cord may not be necessary. A non-replaceable battery may be utilized in order to temporarily store the energy generated by the manual pump 50. The water treatment system may include a charging circuit to efficiently manage the storage of the electrical energy generated by the manual pump 50.

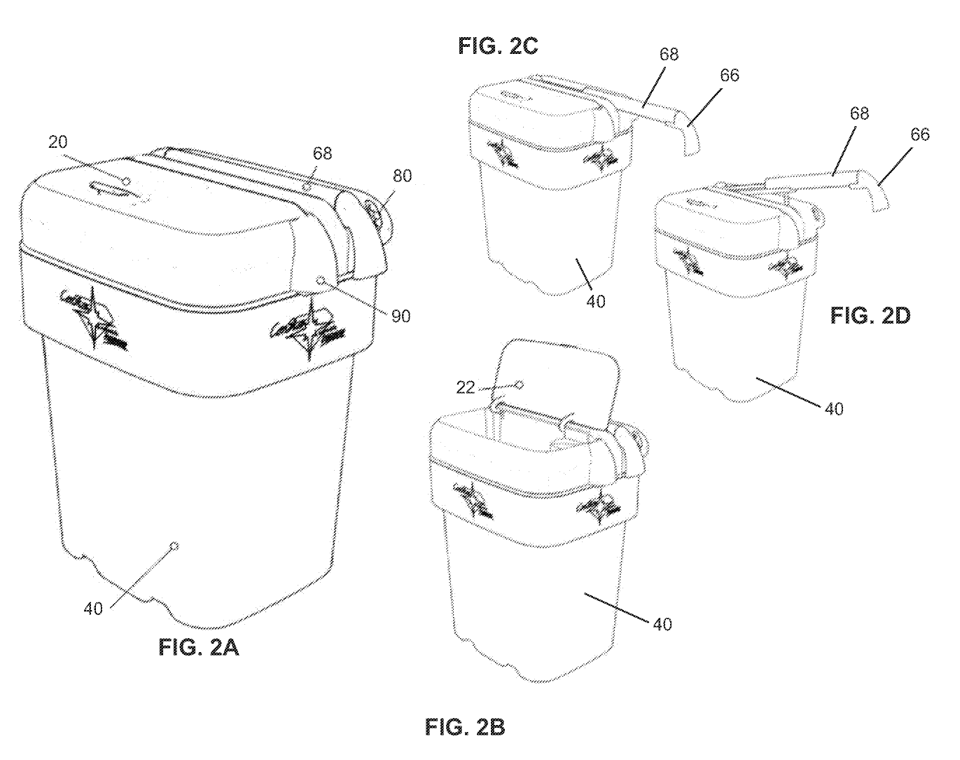

Referring to FIGS. 2A-2D, one embodiment of a water treatment system with a telescoping manual pump 50 is illustrated. While retracted, the pump lever 68 contributes to the compact water treatment system profile and minimizes the bulk associated with the water treatment system. Further, while the pump lever 68 is in a retracted state, it is easier to transport the water treatment system. In operation, as shown in the drawings, the telescoping pump lever 68 of the current embodiment can be extended (FIG. 2C) with the handle 66 and then raised (FIG. 2D) in order to pump water through the water treatment system. The current manual pump 50 is designed to only pump water as the pump lever 68 is raised. While the pump lever 68 is being lowered, no pressure is provided. This configuration allows a small amount of water to be dispensed, while allowing the pump lever 68 to be returned to its retracted, compact position without having to pump additional water. In the current embodiment, the manual pump 50 draws water through the system directly. In alternative embodiments, the pump 50 may be designed to create pressure by filling an air space and using pressure on the air space to move the water through the system. In other embodiments, the pump 50 may have a different configuration. The water treatment system may include a fill lid 22 covering the inlet area 20. In some embodiments, the water treatment system fill lid 22 may be removed, and the inlet 20 may be permanently exposed. In some embodiments the inlet 20 may be configured to accept additional filtration by specialized media or chemicals, such as flocculation, chemical, biological, and particulate contaminant treatment.

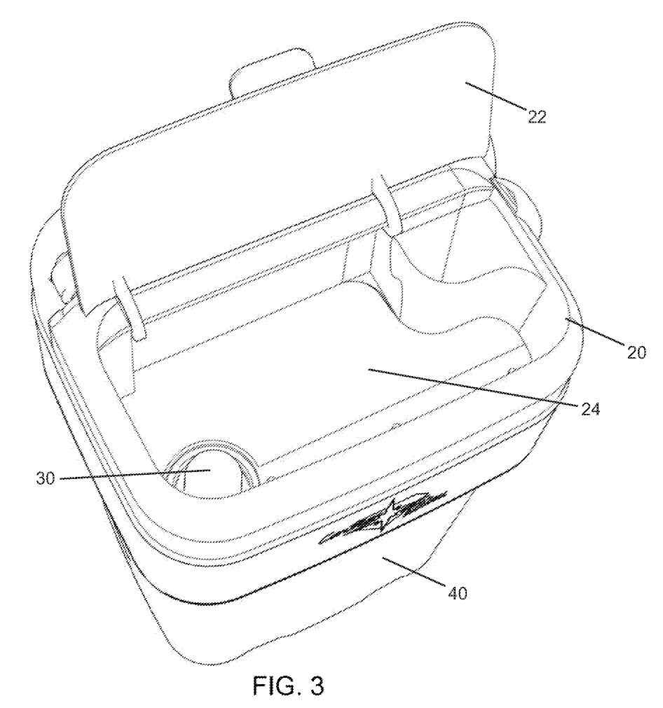

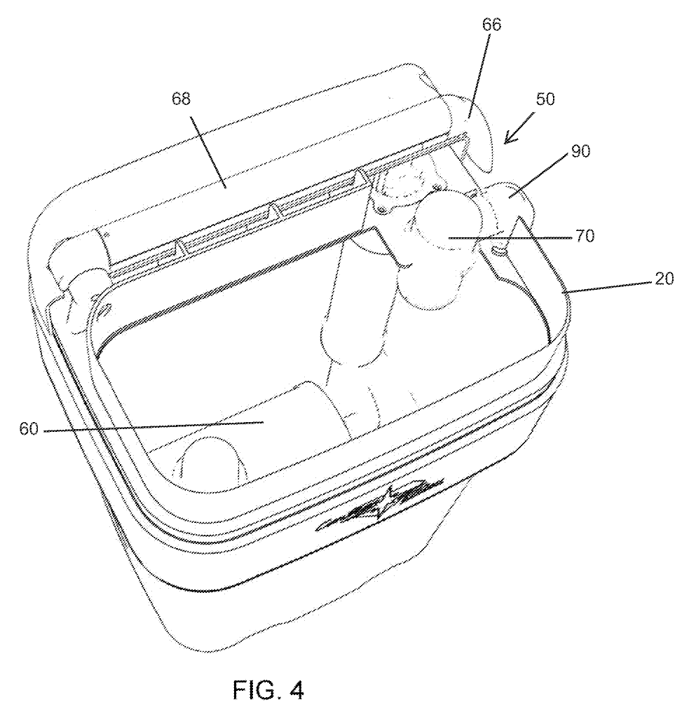

Referring to FIG. 3, the fill lid 22 is in an open position and the inlet cavity 24, where water can be poured into the system, is visible. In FIG. 4, portions of the inlet cavity 24 are removed so that the locations for the pump 50, generator 70, and filter 60 are visible.

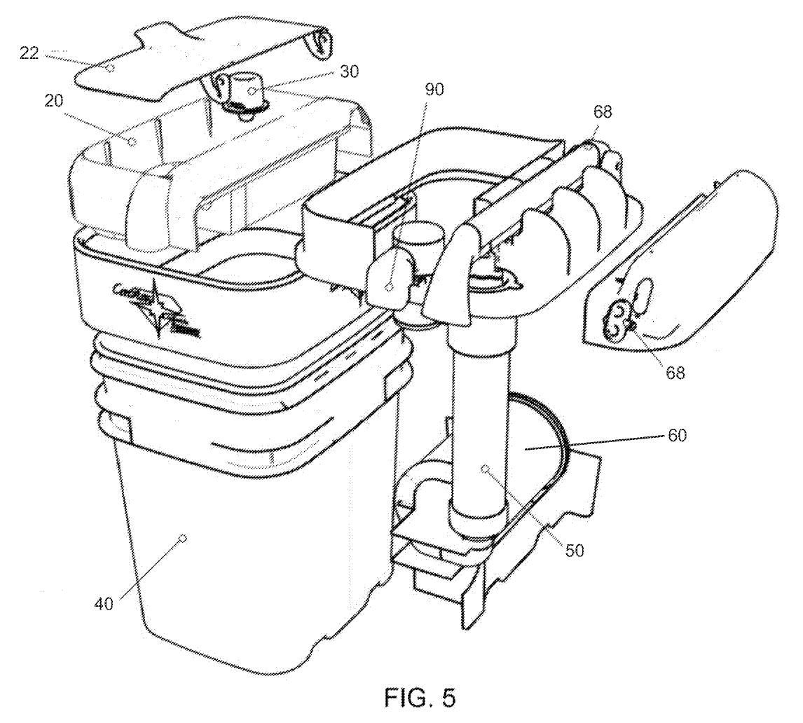

FIG. 5 illustrates an exploded view of one embodiment of the water treatment system. In the illustrated embodiment, the water treatment includes a fill lid 22, a chlorinator 30, an inlet 20, a disinfection contact time container 40, a filter 60, a manual pump 50 with a pump lever 68, a status indicator 80 and processor assembly, and a dispenser port 90. In alternative embodiments, some of these components may be arranged differently, replaced with different components, or deleted entirely. For example, in the current embodiment, the pump 50 is located down stream from the filtration system 60. By using negative pressure to draw water from the storage container 40, the water treatment system inlet 20 does not need to provide any positive pressure. Ultimately, this allows the storage container 40 to be unpressurized, which can reduce cost and complexity of the water treatment system. Further, locating the pump 50 down stream from the filtration 60 can help protect the pump 50 from fouling and wearing due to water contaminants, such as corrosive chemicals and particulates that can be filtered out.

FIG. 6 illustrates the water path through the water treatment system in an exploded view and an assembled view. Water is poured into the system through the chlorinator 30 where it is held in the storage tank 40 with the filter 60 until the manual pump 50 is activated. The manual pump 50 includes a chamber 52, a rod 54, and a disk 56. The disk 56 may include a disk check valve that allows water to flow through the disk 56 during the down stroke of the disk 56, but that does not allow water to flow through the disk 56 during the up stroke of the disk 56. During the up stroke of the disk 56 (and the up stroke of the pump lever 68), the pump 50 creates negative pressure in chamber 52 and in the plumbing 62 adjacent filter 60, which draws water through the filter 60, through the plumbing 62, through a check valve assembly 64 and into the pump chamber 52. The check valve assembly 64 may be positioned upstream of or within the pump chamber 52. Once the water is in the pump chamber 52, the check valve assembly 64 prevents the water from flowing back into the plumbing 62. Optionally, the check valve assembly 64 may be eliminated if the filter 60 provides sufficient back pressure to maintain water in the pump chamber 52. During the down stroke of the disk 56, the disk check valve opens and allows the water in the pump chamber 52 to flow through the disk 56. As discussed above, the down stroke of the disk 56 may not move water through the filter 60 and through the dispenser port 90, and therefore may substantially maintain the position of the water within the water treatment system. During the subsequent up stroke of the disk 56, the disk check valve closes and the water is forced upward out of the pump chamber 52, through the generator/counter 70 and finally is dispensed out of the dispenser port 90. In this manner, the up stroke of the manual pump 50 simultaneously provides negative pressure to draw water from the container 40, through the filter 60 and into the pump chamber 52, and positive pressure to force water from the pump chamber 52 out of the water treatment system through the dispenser port 90. In alternative embodiments, the water flow path may be different.

The chlorinator 30 of the current embodiment is located in the inlet container 24 so that it is visible every time the fill lid 22 is opened. The chlorinator 30 provides an inlet 32, an outlet 34, and a surface or slotted disk 36 for the chlorine tablet. In the current embodiment, a transparent plastic shell 38 interfits with a slotted disk 36 such that water can enter through inlet holes 32 near the bottom of the plastic shell and interact with the chlorine tablet located on the slotted disk 36. By making the plastic shell 38 transparent, not only is the chlorinator 30 visible, but the chlorine tablet within the chlorinator 30 is visible when the fill lid 22 is opened. This allows a user to easily examine and replace the chlorine tablet if necessary, every time the water treatment system fill lid 22 is opened. In use, depending on the configuration, some of the water interacts with the chlorine tablet and some does not. Varying the size, shape and number of holes for the inlet 32 and outlet 34 allows the dosage of chlorine to be adjusted. The size, shape, and location of the chlorine tablet can also be selected based on the desired chlorine dosage. In the current embodiment a sufficient amount of chlorine is provided to ensure that while water is held in the storage container 40 bacteria cannot regrow and reinfect the water between uses of the water treatment system. In the current embodiment, the chlorinator 30 does not require any tools to install or maintain. In one embodiment the chlorinator 30 may be a disposable or replaceable assembly thereby increasing convenience and limiting user contact with the chlorine media. In one embodiment the chlorinator 30 may be disassembled, recharged, for example by replacing a depleted chlorine tablet, and returned to service. In another embodiment the chemical disinfectant may be bromine or iodine. In another embodiment the chemical disinfection may be liquid and dispensed into the water stream or storage container by venturi orifice or pump method. In another embodiment the chemical disinfection may be powder and dispensed into the water stream or storage container.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of the current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A water treatment system including:
an inlet;
a disinfection system in fluid communication with the inlet;
a disinfection contact time container in fluid communication with the disinfection system;
a filter in fluid communication with the disinfection contact time container;
a manual pump located down stream from the filter that provides negative pressure for moving water through the water treatment system;
a hydro generator powered by the water moved by the manual pump; and
an outlet for dispensing the water.

2. The water treatment system of claim 1 wherein the inlet includes an inlet container and the disinfection system includes a disinfection tablet, the disinfection system and disinfection tablet located in the inlet container, and
wherein the disinfection system includes a transparent portion, such that the disinfection tablet is visible while pouring water into the system.

3. The water treatment system of claim 1 wherein the manual pump has a low and erratic water pressure profile, the water pressure profile being capable of running the hydro generator to produce electricity sufficient for active and automatic monitoring of a characteristic of the water treatment system.

4. The water treatment system of claim 3 including a counter that counts the amount of water that flows through the system.

5. The water treatment system of claim 1 wherein the manual pump provides both a high flow rate and automatic dispensing of the water.

6. The water treatment system of claim 5 wherein the flow rate is at least 6 fluid ounces per stroke of the manual pump.

7. The water treatment system of claim 1 wherein the filter is a high removal carbon block filter with a substantial flow resistance and the manual pump produces sufficient negative pressure to overcome the substantial flow resistance of the high removal carbon block filter.

8. The water treatment system of claim 1 wherein the pump is a one way pump that includes a pump lever,
wherein a movement of the pump lever in a first direction allows metering of the water amount by stopping the movement in the first direction,
wherein a movement of the pump lever in a second direction does not move the water through the water treatment system.

9. The water treatment system of claim 8 wherein the pump lever is telescoping.

10. The water treatment system of claim 9 wherein the manual pump includes a disk, the disk including a disk check valve that opens during a movement of the disk in the second direction and closes during a movement of the disk in the first direction.

11. The water treatment system of claim 10 wherein the manual pump includes a pump chamber and wherein a check valve is positioned one of upstream and within the pump chamber.

12. A water treatment system including:
an inlet;
a container in fluid communication with the inlet;
a filter in fluid communication with the container;
a manual pump in fluid communication with the filter for moving the water through the system, the manual pump having a pump lever;
a generator powered by the water moving through the system; and
an outlet for dispensing water from the system,
wherein a movement of the pump lever in a first direction simultaneously creates negative pressure adjacent the filter to draw water through the filter and creates positive pressure to force water through the outlet,
wherein the pump lever may be stopped during the movement in the first direction and moved in a second direction without dispensing water.

13. The water treatment system of claim 12 wherein the container is not pressurized.

14. The water treatment system of claim 13 wherein the container is positioned mid process within the water treatment system.

15. The water treatment system of claim 14 including a chemical disinfectant positioned at an inlet to the container.

16. The water treatment system of claim 12 including a pump chamber and a check valve, wherein the movement of the pump lever in the first direction draws water through the check valve and into the pump chamber.

17. The water treatment system of claim 16 wherein the movement of the pump lever in the first direction forces water out of the pump chamber, through the generator, and through the outlet.

18. A method of treating water for consumption including:
introducing water into an inlet cavity;
allowing the water to move from the inlet cavity to a container using gravity; and
activating a manual pump to:
(i) create negative pressure to draw the water from the container through a filter, and
(ii) create positive pressure to move the water through a generator and through an outlet.

19. The method of claim 18 including allowing the water to move from the inlet cavity, through a disinfectant agent doser and into the container using gravity.

20. The method of claim 19 including
moving a manual pump lever in a first direction away from a home position to activate the manual pump; and
stopping the manual pump lever during the movement in a first direction and moving the manual pump lever in a second, opposite direction to return the manual pump lever to the home position, including substantially maintaining the position of the water in the water treatment system during the movement of the manual pump lever in the second direction.
